(19) United States
(12) Patent Application Publication
(10) Pub. No.: US 2022/0002640 A1
(43) Pub. Date: Jan. 6, 2022

(54) Composition for Solidification of Human Spit and Vomit

(71) Applicant: Ritu Bharat MALHOTRA, Nagpur (IN)

(72) Inventor: Ritu Bharat MALHOTRA, Nagpur (IN)

(21) Appl. No.: 17/326,268

(22) Filed: May 20, 2021

(30) Foreign Application Priority Data
Jul. 3, 2020 (IN) 202021028361

(51) Int. Cl. C11D 3/48; A01N 37/10; C11D 7/26

(52) U.S. Cl. CPC C11D 3/48; C11D 7/261; A01N 37/10

(57) ABSTRACT

The present invention provides a composition for solidification of human spit & vomit. The composition is having a sodium polyacrylate in 10 gram by weight, a food grade color, an aromatic compound in 5 by volume, an aromatic oil in 5 millilitre by volume, an antibacterial polymers in the range between 2 gram by weight, a polybio masterbatches in 2 gram by weight, acetic acid in 5 gram by weight, a sanitizer in 50 millilitre by volume. The composition has an advantage of preventing from germs. Also, the composition has an advantage of being tamper proof. This composition will be used in multiple Devices like—any type of Pouches, containers, Boxes, Cup, jars, mugs, bins, bottles etc.

### FIELD OF THE INVENTION

The present invention relates to a composition for solidification. More particularly, the present invention relates to a composition for solidification of human spit and vomit.

### BACKGROUND OF THE INVENTION

Generally, human spit and vomit may include contagious bacteria and other hazardous microbes.

Further, these human spits and vomits contains an insoluble liquid which is hard to dissolve with the water when dumped into the rivers and oceans. This generates huge amount of germs and bacteria in the surrounding that causes lot health problems such as respiratory infections, heart disease, malaria etc. Also, the collection of the insoluble liquid around rivers and oceans creates bad odour in the surrounding.

As on date, there is no such method which can overcome the problems associated with the solidification of the human spit and vomit.

Therefore, there is a need for a method which can overcome the limitations of the existing prior art.

### OBJECTS OF THE INVENTION

Object of the present invention is to provide a composition for solidification of human spit and vomit.

Another object of the present invention is to provide a composition for solidification of human spit and vomit.

Yet another object of the present invention is to provide a composition for solidification of human spit and vomit.

Further object of the present invention is to provide a composition for solidification of human spit and vomit.

### SUMMARY OF THE INVENTION

According to the present invention, there is provided a composition for solidification of human spit and vomit. The composition is having a sodium polyacrylate in 10 gram by weight, a food grade colour mixed with water, an aromatic compound in 5 millilitre by volume. Also, the composition is having an aromatic oil in 5 Millilitre by volume, an antibacterial polymer in 2 gram by weight, a polybio masterbatches in 2 gram by weight, and acetic acid in 5 gram by weight and a sanitizer in 50 Millilitre by volume.

In the present embodiment, the sodium polyacrylate is a water lock. Also, the sodium polyacrylate is in powdered form. The food grade color is selected from the group of anthocyanins, curcuma, annatto, cu-chlorophyllin, caramel and the like. The aromatic compounds are selected from the group of amino acids histidine, phenylalanine, tryptophan, tyrosine and the like. Furthermore, the aromatic oils are selected from the group of anise oil, camphor oil, basil oil, calamodin oil and the like.

Moreover, the antibacterial polymer is selected from the group of acrylonitrile butadiene styrene (ABS), ethylene vinyl acetate (EVA), high impact polystyrene (HIPS), polyethylene (PE), polymethyl methacrylate (PMMA), polypropylene (PP), silicone and the like. In the present embodiment, the acetic acid is in powdered form.

### DETAILED DESCRIPTION OF THE INVENTION

An embodiment of this invention, illustrating its features, will now be described in detail. The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items.

The present invention provides a composition for a composition for solidification of human spit and vomit. Also, the composition prevents spreading of germs. The composition is tampered proof. Furthermore, the composition is simple and economical in operation.

According to the present invention, a composition for solidification of human spit and vomit in accordance with the present invention is illustrated. The present composition includes a sodium polyacrylate, food grade color, aromatic compound, aromatic oil, antimicrobial polymers, polybio masterbatches, acetic acid and sanitizer. The sodium polyacrylate is 10 gram by weight. The sodium polyacrylate is a water lock. In the present embodiment, the sodium polyacrylate is used in the powdered form. The sodiumpolyacrylate is a sodium salt of polyacrylic acid. Also, the sodium polyacrylate is a super absorbent polymer acid which has the ability to absorb 100 to 1000 times its mass in water. The food grade colour is selected from the group of anthocyanins, curcuma, annatto, cu-chlorophyllin, caramel and the like.

The food grade colour is used to give a naturally appealing colour and texture to the composition. The food grade colour is added to the sodium polyacrylate along with water. The quantity of water ranges from 50 millilitre to 100 millilitre of the total volume of the composition 100.The aromatic compound is 5 millilitre by volume. The aromatic compounds are selected from the group of amino acids histidine, phenylalanine, tryptophan, tyrosine and the like. The aromatic compound is added to give the aroma to the composition.

Further, the aromatic oil is in 5 millilitre by volume. The aromatic oils is selected from the group of anise oil, camphor oil, basil oil, calamodin oil and the like. The aromatic oils are added to form the composition. Also, the antibacterial polymer is in 2 gram by weight. The antibacterial polymer is selected from the group of acrylonitrile butadiene styrene (ABS), ethylene vinyl acetate (EVA), high impact polystyrene (HIPS) polyethylene (PE), polymethyl methacrylate (PMMA), polypropylene (PP), silicone and the like. The antibacterial polymer is added to prevent the composition from bacteria and other form of germs.

Furthermore, the polybio masterbatches is added to the composition in 2 gram by weight. The polybio masterbatches is used to accelerate the degradation of the plastics thereby, disposing the liquid waste at a faster rate. The acetic acid is in 5 gram by weight and a sanitizer is in 50 Millilitre by volume.

The composition is prepared in a form of powder or in a liquid. The composition is poured on a human spit or on a vomit spread. The composition solidifies the human spit or on a vomit spread. This composition can be used in multiple devices like—any type of Pouches, containers, Boxes, Cup, jars, mugs, bins, bottles etc.

Therefore, the present invention provides the advantage of composition for solidification of liquid waste. Also, the composition prevents spreading of germs. The composition is tampered proof. Furthermore, the composition is simple and economical in operation.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

I claim:

1. A composition for solidification of a liquid waste; the composition comprising:
a sodium polyacrylate in 10 gram by weight;
a food grade color;
an aromatic compound is added in 5 millilitre by volume;
an aromatic oil is added in 5 millilitre by volume;
an antibacterial polymer is added in the range between 2 gram by weight;
a polybio masterbatches is added in 2 gram by weight;
acetic acid is added in 5 gram by weight; and
a sanitizer is added in 50 millilitre by volume to form the composition.

2. The composition as claimed in claim 1, wherein the sodium polyacrylate is a water lock.

3. The composition as claimed in claim 1, wherein the sodium polyacrylate is in powdered form.

4. The composition as claimed in claim 1, wherein the food grade color is selected from the group of anthocyanins, curcuma, annatto, cu-chlorophyllin, caramel and the like.

5. The composition as claimed in claim 1, wherein the aromatic compounds are selected from the group of amino acids histidine, phenylalanine, tryptophan, tyrosine and the like.

6. The composition as claimed in claim 1, wherein the aromatic oils are selected from the group of anise oil, camphor oil, basil oil, calamodin oil and the like.

7. The composition as claimed in claim 1, wherein the antibacterial polymer is selected from the group of acrylonitrile butadiene styrene (ABS), ethylene vinyl acetate (EVA), high impact polystyrene (HIPS)□ polyethylene (PE), polymethyl methacrylate (PMMA), polypropylene (PP), silicone and the like.
